(19) United States
(12) Patent Application Publication
(10) Pub. No.: US 2015/0274156 A1
(43) Pub. Date: Oct. 1, 2015

(54) METHOD FOR DRIVER IDENTIFICATION OF PREFERRED ELECTRIC DRIVE ZONES USING A PLUG-IN HYBRID ELECTRIC VEHICLE

(71) Applicant: FORD GLOBAL TECHNOLOGIES, LLC, Dearborn, MI (US)

(72) Inventors: Anthony Mark PHILLIPS, Northville, MI (US); Johannes Geir KRISTINSSON, Ann Arbor, MI (US); Jeffrey Lee HENTSCHEL, Novi, MI (US)

(73) Assignee: FORD GLOBAL TECHNOLOGIES, LLC, Dearborn, MI (US)

(21) Appl. No.: 14/230,017

(22) Filed: Mar. 31, 2014

(51) Int. Cl. B60W 20/00; B60W 10/08; B60W 10/26; B60W 10/06

(52) U.S. Cl. CPC B60W 20/40; B60W 10/06; B60W 10/08; B60W 10/26; Y10S 903/93

(57) ABSTRACT

A method for controlling a powertrain in a hybrid vehicle includes operating in an electric only mode in response to a detected vehicle location being within a designated geographic area. The designated geographic region is designated in response to at least one user selection that was input during a previous drive cycle. The designated geographic region also includes the vehicle location where the user selection was input.

### TECHNICAL FIELD

The disclosure relates to automotive vehicles and to designating geographic boundaries in relation to which a vehicle control strategy or operating mode may be modified.

### BACKGROUND

Hybrid electric vehicles (HEVs) include engines that may be stopped and started while the vehicle is in motion. When the engine is stopped while the vehicle is in motion, the hybrid vehicle may operate in an “electric only” mode. A controller may issue stop (or “pull down”) or start (or “pull up”) commands to the engine in response to various conditions including a reduced battery state of charge. Plug-in hybrid electric vehicles (PHEVs) are generally equipped with larger batteries and may travel longer distances than other HEVs in electric only mode.

### SUMMARY

A method for controlling a powertrain in a hybrid vehicle includes operating in an electric only mode in a current drive cycle in response to a detected vehicle location being within a designated geographic area. The boundaries of the designated geographic area are defined in response to at least one user selection that was made during a previous drive cycle. The designated geographic area also includes the vehicle location where the user selection was input.

In one embodiment, the at least one user selection comprises a first user selection and a second user selection. In such an embodiment, the designated geographic area is defined along a path between a first detected coordinate and a second detected coordinate. The first coordinate corresponds with the first user selection and the second coordinate corresponds with the second user selection. In another embodiment, the designated geographic area is defined along a path between a first detected coordinate and a second coordinate. The first coordinate corresponds with the at least one user selection and the second coordinate corresponds with an end point of the previous drive cycle. In one embodiment, the end point is defined by a key off event. In some embodiments, the at least one user input additionally comprises a third user input confirming the designation of the geographic area.

In one embodiment, the path may correspond with a route traversed by the vehicle between the first user selection and the second user selection. In another embodiment, the designated geographic area includes a circular region encompassing the path between the first and second coordinates. The circular region may be centered on the second coordinate. In yet another embodiment, the designated geographic area includes connected roads in the same road class as a road on the path between the first and second coordinates. Connected roads in the same road class may have an equal number of lanes and equal speed limit to the road on the path.

A hybrid vehicle according to the present invention includes an internal combustion engine, an electric drive system, and a controller. The controller is configured to disable the internal combustion engine and operate the vehicle in an electric only mode in response to a detected vehicle location within a specified geographic region. The specified geographic region is specified in response to at least one user selection that was input during a previous drive cycle. The specified geographic region bounds a location where the user selection was input.

In some embodiments, the at least one user selection includes a first user selection and a second user selection. The specified geographic region may correspond with a route traversed by the vehicle between the first user selection and second user selection. In another variant, the specified geographic region includes a circular region encompassing a route traversed by the vehicle between a first coordinate and a second coordinate, where the first coordinate corresponds with the first user selection and the second coordinate corresponds with the second user selection. In yet another variant, the specified geographic region includes connected roads in the same road class as a road traversed by the vehicle between a first coordinate and a second coordinate, where the first coordinate corresponds with the first user selection and the second coordinate corresponds with the second user selection. In some embodiments, the at least one user selection includes a user choice of one among a plurality of proposed geographic regions.

A vehicle according to the present disclosure includes a user interface and at least one controller. The controller is configured to define a geographic boundary in response to at least a first user input. The geographic boundary encompasses a route driven between a first coordinate and a second coordinate, where the first coordinate corresponds with the first user input. The controller is additionally configured to control the vehicle in a first mode in response to the vehicle being within the geographic boundary and to control the vehicle in a second mode in response to the vehicle location not being within the geographic boundary.

In one embodiment, the vehicle additionally includes an internal combustion engine, a fraction battery, and a traction motor. In such an embodiment, controlling the vehicle in a first mode includes inhibiting the internal combustion engine and operating the traction battery and traction motor in an electric only mode. In another embodiment, controlling the vehicle in a second mode includes transmitting an alert to a remote device.

Embodiments according to the present disclosure provide a number of advantages. For example, the present disclosure provides a method for defining a geographic zone based largely upon kinetic motion of the car, rather than through a user interface. This may be used, for example, to easily define a region within which the vehicle is to be operated in an electric-only mode.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 schematically illustrates a hybrid electric vehicle;

FIGS. 2A-2F illustrate capturing various geographic zone shapes based on a driven vehicle route;

FIG. 3 is a flowchart illustrating a method of capturing a geographic zone based on a driven vehicle route; and

FIG. 4 is a flowchart illustrating a method of controlling a vehicle in response to a location relative to a stored geographic zone.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

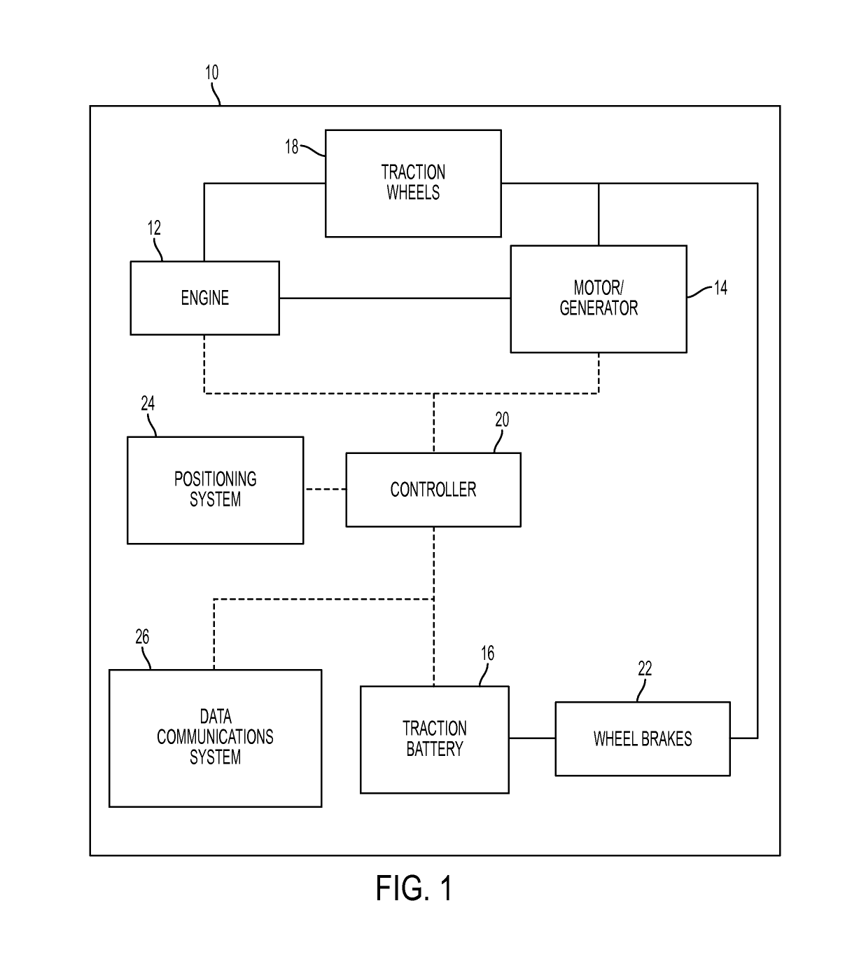

Referring now to FIG. 1, the powertrain of a PHEV 10 includes an engine 12, at least one electric motor/generator 14, and a traction battery 16. The engine 12 and the motor/generator 14 are each provided with torque transmission paths to vehicle traction wheels 18. The engine can also charge the fraction battery 16 through the motor/generator 14. The engine 12, motor/generator 14, and traction battery 16 are all in communication with or under the control of at least one controller 20. The controller 20 may be a vehicle systems controller, a combination of an engine system controller and a battery system controller, or other controllers as appropriate. Vehicle kinetic energy may also be recovered and regenerated using wheel brakes 22 to drive the motor/generator and recharge the battery. The PHEV 10 further includes an externally-accessible electrical interface (not shown) for plugging into a charging station.

The PHEV 10 additionally includes a positioning system 24, such as a GPS system, and a data communications system 26. The positioning system 24 and the data communications system 26 are both in communication with or under the control of controller 20. The data communications system 26 may include a cellular data communications device, WiFi, or other appropriate communications devices.

The PHEV 10 is configured to operate in an “electric only” mode. In this mode, the engine 12 is stopped and inhibited from restarting. The motor/generator 14 provides torque to the traction wheels 18 using stored electric energy from the traction battery 16. In electric only mode, regenerative braking is still available to recover kinetic energy as stored electric energy. To avoid over-depleting the traction battery 16, a battery state of charge threshold is provided. This threshold may be referred to as a battery charge sustaining level. As a non-limiting example, the battery charge sustaining level may be set at approximately 30% battery SOC. If the battery state of charge falls below the sustaining level, then the engine 12 may be started in order to charge the traction battery 16. The engine 12 may be started in response to a command from controller 20 or other controllers as appropriate.

In some areas, it is preferable for the vehicle to remain in electric only mode for as long as possible. As an example, the vehicle operator may prefer to operate in electric only mode in a designated geographic region, such as his or her neighborhood, to reduce local pollution and/or noise. Additionally, some cities and/or highways provide incentives for operation in electric vehicle mode. Collectively, these and other regions in which it is desirable to operate in electric only mode may be referred to as “Green Zones.”

Similarly, there are other situations aside from green zones in which it is desirable to designate a geographic region or geofence, in relation to which a vehicle may operate in various different modes or perform specified actions. As an example, a parent of a young driver may desire to establish a boundary within which the young driver is authorized to drive. The vehicle may be configured to send a signal to a remote device, such as an SMS message to a cellular phone, when the vehicle leaves such a boundary. Such a function could also be used to alert a driver if the vehicle leaves the normal driving area, helping to deter vehicle theft. Other uses of such a boundary are of course possible. Such uses are, of course, not necessarily limited to use within hybrid electric vehicles.

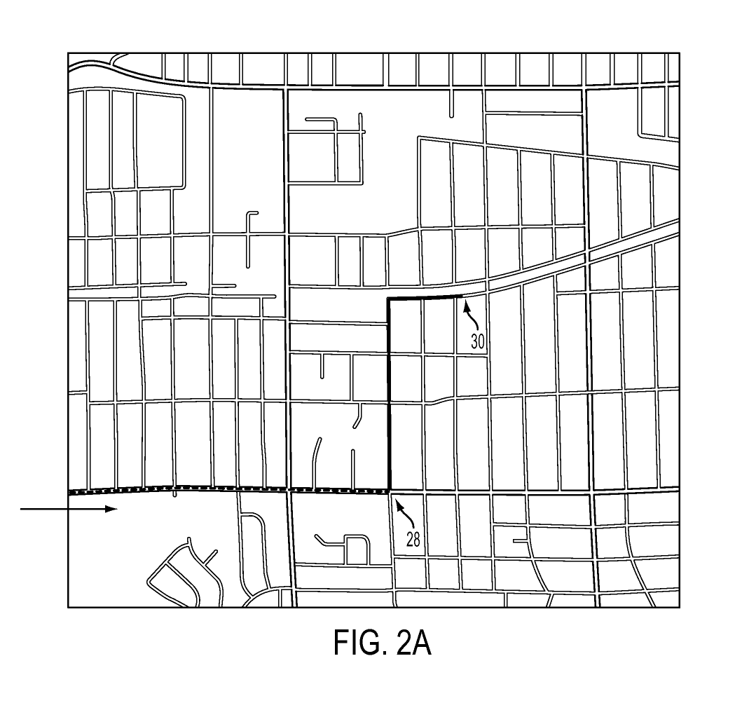

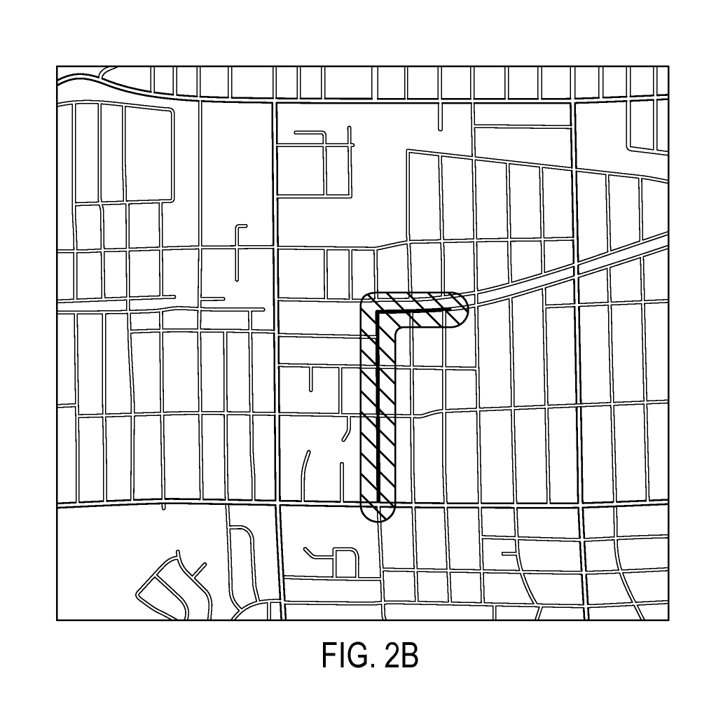

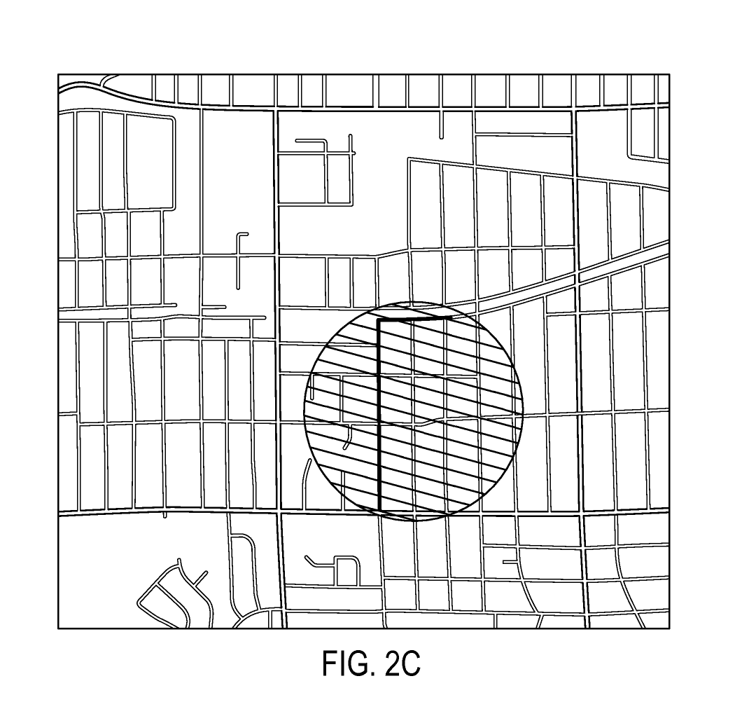

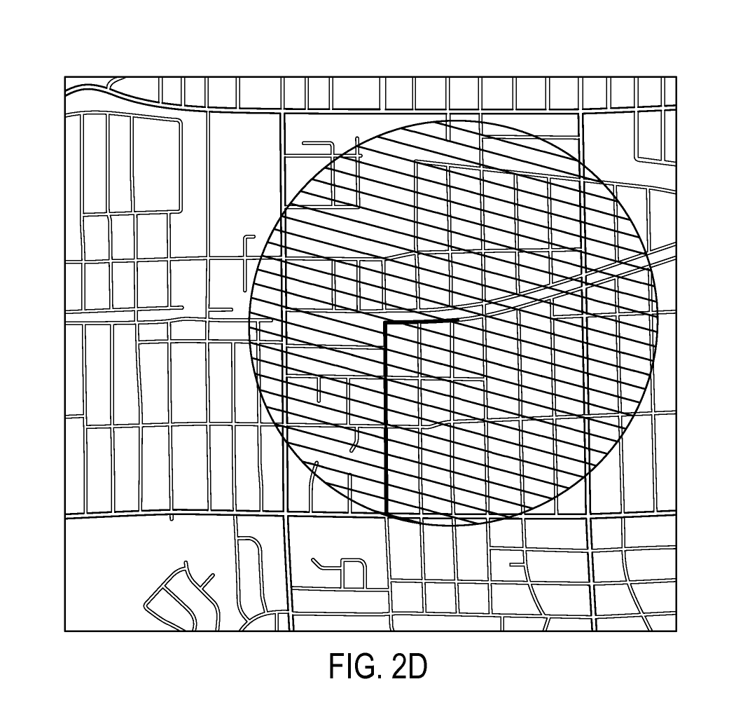

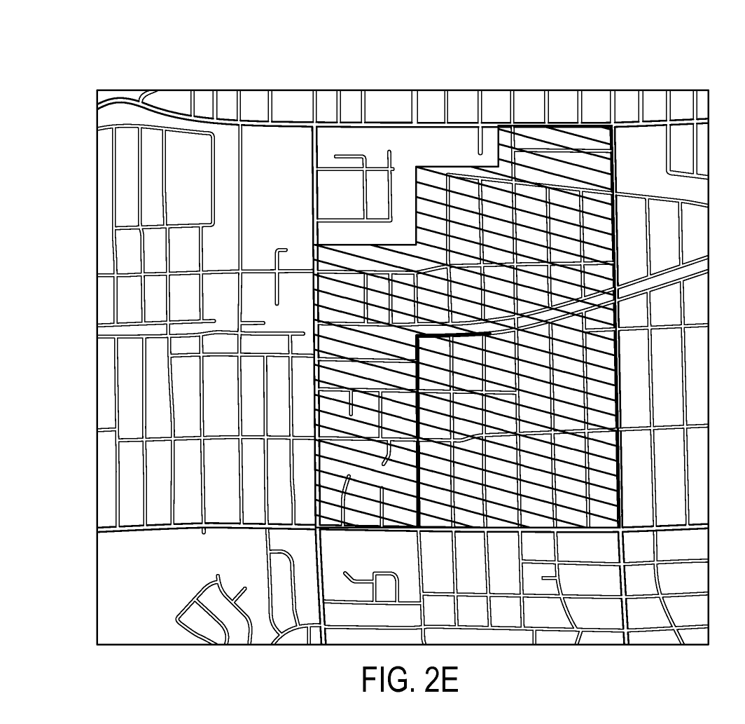

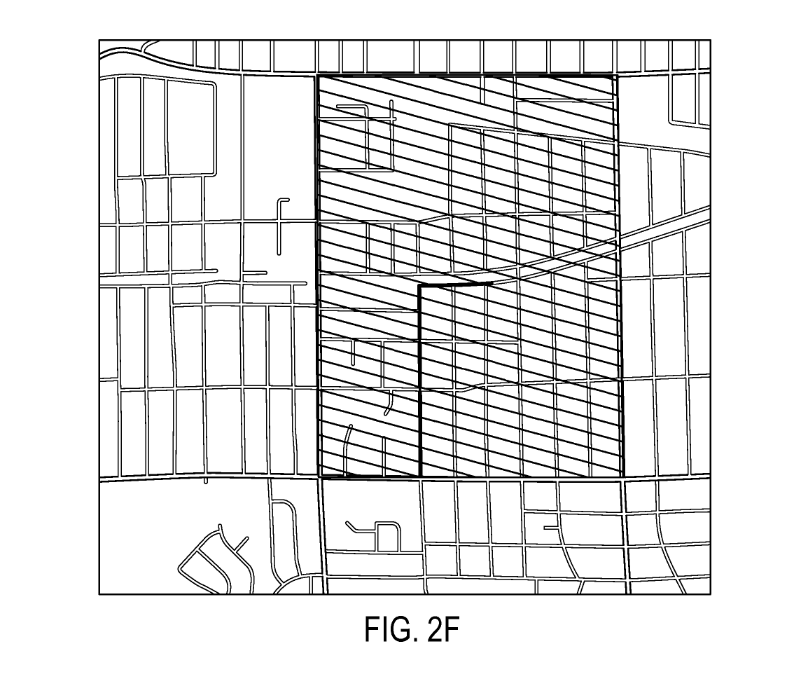

Referring now to FIG. 2A, a vehicle route is illustrated. The vehicle drives along the route indicated by the dashed line in the direction indicated by the arrow. At the intersection indicated at numeral 28, the vehicle turns off of a major street onto a neighborhood street. After doing so, the driver commands the vehicle to begin learning the route. This may be performed, for example, by making a selection on a user interface. In vehicles equipped for voice control, this may be performed via a voice command. After receiving this command from the driver, the vehicle records the route subsequently traversed by the vehicle, as illustrated by the solid line. At the point indicated at numeral 30, the vehicle reaches its destination and recording is stopped. The recording may be stopped in response to a user input commanding the end of the route recording. In some embodiments, the recording may be stopped in response to a signal indicative of the end of the present drive cycle, such as a key-off event. The driver may also command that the route recording be stopped prior to the end of the present drive cycle.

The recorded route may be used to define a variety of shapes of geographic boundaries. Referring now to FIG. 2B, a simple geographic boundary configuration may include only the driven route, with a small radius to ensure that the road traversed by the vehicle is fully included within the boundary. In some embodiments, the radius is adjustable. An example of such a boundary is indicated by the cross-hatched area.

Referring now to FIG. 2C, another geographic boundary configuration would include the region bounded by a circle sized to encompass the route. In the example embodiment illustrated in FIG. 2c, the circle is sized such that the boundary encompasses the route with only a small margin; the margin may of course be calibratable or pre-set to various levels.

Referring now to FIG. 2D, another example of a circular geographic boundary configuration includes the region bounded by a circle centered on the end point of the route and sized to encompass the route. Such a configuration may be desirable in, for example, a neighborhood or subdivision. In such a scenario, a driver may wish to ensure that other routes through the neighborhood to a final vehicle destination are also within the designated geographic boundary.

Referring now to FIG. 2E, another geographic boundary configuration includes all roads in a same class that are connected to a road on the saved route. The road class may be defined, for example, based on speed limit, number of lanes, and/or other factors. In the example illustrated in FIG. 2E, the geographic boundary includes the neighborhood roads bounded by the major roads, with the exception of the roads in the region indicated at numeral 32. These roads do not connect to the driven route except through more major roads.

Referring now to FIG. 2F, another geographic boundary configuration would include all roads within an area bounded by more major roads. In the example illustrated in FIG. 2F, the geographic boundary includes all neighborhood roads bounded by the major roads, including those indicated at numeral 32′ which are not directly connected to roads on the vehicle route. In some embodiments, this type of configuration may be provided with an adjustable sensitivity, such that the bounding major road may be selected to be major surface streets of varying degrees or a bounding highway. Some cities are encircled by highways; for example, Cincinnati, Ohio is bounded by interstate 275. By adjusting the sensitivity, this type of zone configuration could be adapted to include an entire city surrounded by a highway.

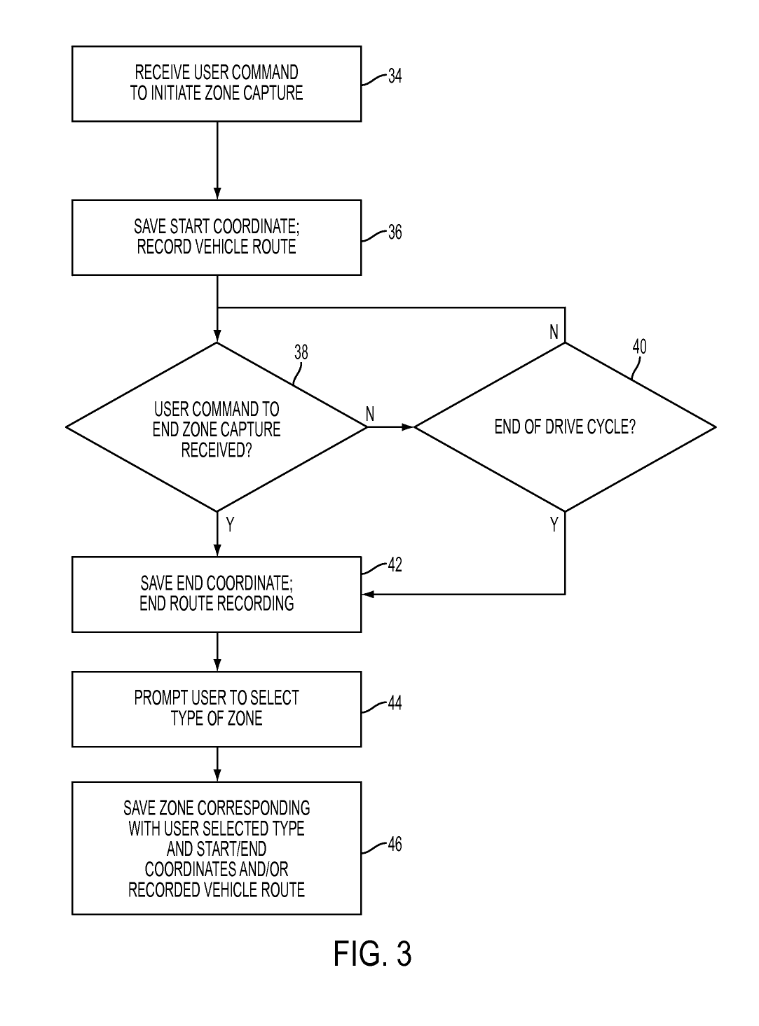

Referring to FIG. 3, a flowchart illustrates a method of capturing a geographic boundary. A user command to initiate zone capture is received, as illustrated at block 34. In various embodiments the user command may include a driver pressing a physical button in the vehicle, making a selection on a touch screen display in the vehicle, issuing a voice command to the vehicle, or making a selection on a mobile device that is in communication with the vehicle. This command may, of course, also be issued in various other ways. After the user command is received, the start coordinate, or the geolocation of the vehicle when the zone capture command is received, is saved and vehicle route recording is initiated, as illustrated at block 36. Vehicle route recording may include storing a series of geolocation coordinates, or “breadcrumbs”, or other storage methods as appropriate.

A determination is then made of whether a user command to end the zone capture process has been received, as illustrated at operation 38. If no, then a determination is made of whether the current drive cycle has ended, as illustrated at operation 40. In various embodiments, this may be determined based on an engine key-off event, the disconnection of a mobile device from the vehicle, or other appropriate indicators that the drive cycle has ended. If no, then control returns to operation 38. In this fashion, the algorithm monitors for either a user command or the end of the driving cycle.

If a determination is made that the drive cycle has ended at operation 40, then the end coordinate, or the geolocation of the vehicle when the drive cycle is ended, is saved and route recording is ended. Similarly, if a determination is made that a user command to end the zone capture process is received at block 38, the end coordinate corresponding to the user command is saved and route recording is ended.

The user is then prompted to select a type of zone, as illustrated at block 44. The available zone types may correspond with those illustrated in FIGS. 2B-2F, or may represent a subset or augmented set of zone types relative to those illustrated. This prompt may include a visual depiction of the map region covered by the various zone types, a verbal description of the zone (e.g. “circular”, “connected roads”, etc.), a combination thereof, or other prompts as appropriate. This prompt may also include range options, enabling the user to select a zone size. The zone corresponding with the user selected type, the start and end coordinates, and/or the recorded vehicle route is saved, as illustrated at block 46.

Variations of the above algorithm are, of course, possible. As an example, an alternative embodiment may omit the step illustrated at block 44, prompting the user to select a zone type. In such an embodiment, the algorithm may be provided with a default zone type by a manufacturer or by the driver.

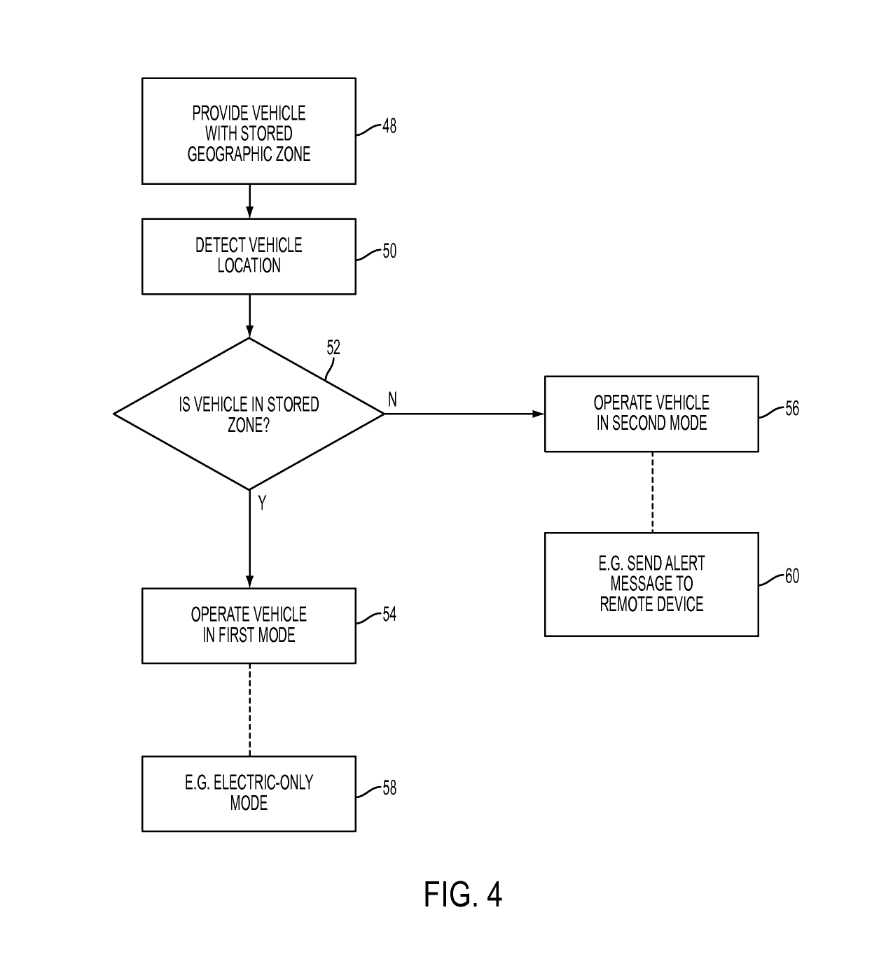

Referring now to FIG. 4, a flowchart illustrates a method of controlling a vehicle in response to a location relative to a stored geographic zone. A vehicle is provided with at least one stored geographic zone, as illustrated at block 48. This may be performed generally as described above with respect to FIG. 3 or via other means. A vehicle location is then detected, as illustrated at block 50. This may be performed using a vehicle navigation system or other appropriate systems. A determination is then made of whether the vehicle is within a stored geographic zone, as illustrated at block 52. If yes, then the vehicle is operated in a first mode, as illustrated at block 54. If no, then the vehicle is operated in a second mode, as illustrated at block 56.

In one embodiment, the first mode is an electric-only mode of operation, as illustrated at block 58. In such an embodiment, a hybrid vehicle may operate according to a default hybrid operation mode when outside the stored zone and in an electric-only mode when inside the stored zone. When performed in combination with the method described in conjunction with FIG. 3, a driver may thus define a green zone while driving, within which the vehicle will operate in an electric-only mode on subsequent drive cycles.

In another embodiment, the second mode of operation includes sending an alert message to a remote device, as illustrated at block 60. This may comprise sending a text message to a cell phone. When performed in combination with the method described in conjunction with FIG. 3, a driver may establish a geographic boundary within which the vehicle may freely operate, but when outside of which the vehicle will alert the driver.

As can be seen from the various embodiments, the present invention provides a system and method for defining a geographic boundary using kinetic motion of the car. The vehicle may subsequently be controlled according to a first mode when inside the geographic boundary and according to a second mode when outside the geographic boundary. This may be used, for example, to easily define a geographic region within which the vehicle is to be operated in an electric-only mode.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A method of controlling a powertrain in a hybrid vehicle comprising:
operating during a current drive cycle in an electric only mode in response to a detected vehicle location being within a designated geographic area, with boundaries of the designated geographic area being defined in response to at least one user selection made during a previous drive cycle and encompassing a vehicle location where the user selection was input.

2. The method of claim 1, wherein the at least one user selection comprises a first user selection and a second user selection and the designated geographic area is defined along a path between a first detected coordinate corresponding with the first user selection and a second detected coordinate corresponding with the second user selection.

3. The method of claim 2, wherein the path corresponds with a route traversed by the vehicle between the first user selection and second user selection.

4. The method of claim 2, wherein the designated geographic area includes a circular region encompassing the path between the first and second coordinates.

5. The method of claim 4, wherein the circular region is centered on the second coordinate.

6. The method of claim 2, wherein the designated geographic area includes connected roads in a same road class as a road on the path between the first and second coordinates.

7. The method of claim 6, wherein connected roads in the same road class have an equal number of lanes and an equal speed limit to the road on the path.

8. The method of claim 2, where the at least one user selection further comprises a third user selection confirming the definition of the designated geographic area.

9. The method of claim 1, wherein the designated geographic area is defined along a path between a first detected coordinate corresponding with the at least one user selection and a second detected coordinate corresponding with an end point of the previous drive cycle.

10. The method of claim 9, wherein the end point of the previous drive cycle is defined by a key off event.

11. A hybrid vehicle comprising:
an internal combustion engine;
an electric drive system; and
a controller configured to disable the internal combustion engine and operate the electric drive system in response to a detected vehicle location being within a geographic region specified in response to at least one user selection input during a previous drive cycle and bounding a location where the user selection was input.

12. The hybrid vehicle of claim 11, wherein the at least one user selection comprises a first user selection and a second user selection and the specified geographic region corresponds with a route traversed by the vehicle between the first user selection and second user input selection.

13. The hybrid vehicle of claim 11, wherein the at least one user selection comprises a first user selection and a second user selection and the specified geographic region includes a circular region encompassing a route traversed by the vehicle between a first coordinate corresponding with the first user selection and a second coordinate corresponding with the second user selection.

14. The hybrid vehicle of claim 11, wherein the at least one user input comprises a first user selection and a second user selection and the specified geographic region includes connected roads in a same road class as a road traversed by the vehicle between a first coordinate corresponding with the first user selection and a second coordinate corresponding with the second user selection.

15. The hybrid vehicle of claim 11, wherein the at least one user selection includes a user choice of one among a plurality of proposed geographic regions.

16. A vehicle comprising:
a user interface; and
at least one controller configured to define a geographic boundary in response to at least a first user selection and to control the vehicle in a first mode in response to a vehicle location being within the geographic boundary and a second mode in response to the vehicle location not being within the geographic boundary, wherein the geographic boundary encompasses a route driven between a first coordinate and a second coordinate and wherein the first coordinate corresponds with the first user selection.

17. The vehicle of claim 16, further comprising an internal combustion engine, a traction battery, and a traction motor, wherein controlling the vehicle in a first mode includes inhibiting engine operation and operating the vehicle in an electric only mode.

18. The vehicle of claim 16, wherein controlling the vehicle in a second mode includes transmitting an alert to a remote device.
